(19) United States
(12) Patent Application Publication
(10) Pub. No.: US 2009/0317078 A1
(43) Pub. Date: Dec. 24, 2009

(54) OPTICAL TRANSMISSION DEVICE AND OPTICAL TRANSMISSION METHOD

(75) Inventors: Tetsuya UDA, Yokohama (JP); Hiroyuki NAKANO, Yokohama (JP); Yasuyuki FUKASHIRO, Yokohama (JP)

Correspondence Address: MATTINGLY & MALUR, P.C., 1800 DIAGONAL ROAD, SUITE 370, ALEXANDRIA, VA, 22314, US

(73) Assignee: HITACHI COMMUNICATION TECHNOLOGIES, LTD., Tokyo (JP)

(21) Appl. No.: 12/487,816

(22) Filed: Jun. 19, 2009

(30) Foreign Application Priority Data
Jun. 19, 2008 (JP) 2008-160488

(51) Int. Cl. H04B 10/08; H04J 14/06

(52) U.S. Cl. 398/29; 398/65; 398/136

(57) ABSTRACT

The signal quality of ultra high-speed signals such as 40 Gbit/s and 100 Gbit/s are significantly degraded due to wavelength dispersion and nonlinear effects in an optical fiber. Thus, there is provided a transponder unit in which a light source is polarization multiplexed in a direction mutually orthogonal to a signal direction, in order to reduce the nonlinear effects in the optical fiber and improve the signal quality. At the same time, it is possible to monitor an amount of the wavelength dispersion in the optical fiber, allowing for more precise dispersion compensation design.

### CLAIM OF PRIORITY

The present application claims priority from Japanese patent application serial no. 2008-160488, filed on Jun. 19, 2008, the content of which is hereby incorporated by reference into this application.

### BACKGROUND OF THE INVENTION

The present invention relates to an optical transmission device and method, and more particularly to an optical transmission device and method for transmitting wavelength division multiplexed optical signals.

Optical transmission systems generally use a wavelength division multiplexing optical transmission technology that communicates with plural optical signals of different wavelengths by combining them into a single optical fiber, in order to reduce system costs while increasing the transmission capacity. Further, in optical transmission systems, an optical fiber amplifier is provided on a transmission line in order to compensate for optical signal loss occurring in an optical fiber, which is a transmission line, between two points apart from each other. The optical fiber amplifier simultaneously amplifies plural optical signals of different wavelengths, without converting an optical signal to an electrical signal during transmission.

A common configuration of an optical add/drop multiplexer (OADM) device will be described with reference to FIG. 1. Here, FIG. 1 is a block diagram of an OADM. In FIG. 1, an OADM 700 includes two optical amplifying units 160, an add/drop unit 140, a transponder unit 170, and a supervisory controller 150. The optical amplifying unit 160 amplifies the intensity of light attenuated during transmission through a transmission line (optical fiber) 50. Further, the optical amplifying unit 160 amplifies the intensity of light to a level sufficient to transmit to the transmission line 50. The add/drop unit 140 extracts a desired signal from plural wavelength multiplexed optical signals. Further, the add/drop unit 140 multiplexes a desired signal into the plural wavelength multiplexed optical signals. The transponder unit 170 appropriately converts the dropped signal from the add/drop unit 140, with respect to a subscriber signal to be accommodated in the OADM 700. Further, the transponder unit 170 converts a signal from a subscriber to an appropriate wavelength, and multiplexes the wavelength thereof by the add/drop unit 140. The supervisory controller 150 monitors and controls the optical amplifying units 160, the add/drop unit 140, and the transponder unit 170.

The optical amplifying unit 160 includes an optical amplifier 161 on the reception side, and an optical amplifier 166 on the transmission side. The reception-side optical amplifier 161 amplifies the intensity of the optical signal received from the transmission line 50. The transmission-side optical amplifier 166 amplifies the intensity of the optical signal received from the add/drop unit 140 and transmits to the transmission line 50.

The add/drop unit 140 includes add/drop units 141 on the drop side, and add/drop units 146 on the add side. The add/drop unit 141 drops a wavelength of the optical signal from the reception-side optical amplifier 161. The add/drop unit 146 adds a wavelength to the optical signal received from the transponder unit 170.

In the OADM 700, an optical signal propagates as indicated by the dotted line. A supervisory optical control signal propagates to a supervisory optical control signal processor 151, which is mounted in the supervisory controller 150, as indicated by the sold line. In other words, the supervisory optical control signal is separated by the optical amplifying unit 160, and is input to the supervisory optical control signal processor 151 of the supervisory controller 150.

The optical signal is amplified by the optical amplifying unit 160, and is input to the add/drop unit 140. Here, the optical signal flow and the supervisory optical control signal flow are shown only in the input directions. However, the signal flows in their output directions are the same as in the input directions.

In the typical OADM 700, extracting a desired signal from plural optical signals, as well as multiplexing a desired signal into the plural signals, are functions performed by the add/drop unit 140.

When the monitoring control signal is communicated between remotely located OADMs 700, only the supervisory control signal is demultiplexed from the wavelength multiplexed light in a supervisory control signal demultiplexer, not shown, provided at the input portion of the optical amplifier 161. Further, the supervisory control signal is multiplexed to the signal wavelength in a supervisory control signal multiplexer, not shown, provided at the output portion of the optical amplifier 166.

The optical amplifying unit, which constitutes a part of the OADM, will be described with reference to FIGS. 2A and 2B. Here, FIGS. 2A and 2B are block diagrams of the optical amplifiers, in which FIG. 2A shows the optical amplifier on the reception side, and FIG. 2B shows the optical amplifier on the transmission side. The optical amplifiers 161, 166 are used in the OADM 700 to simultaneously amplify plural signal wavelengths without separating into individual wavelengths. The optical amplifying unit includes the reception-side optical amplifier 161 and the transmission-side optical amplifier 166. The reception-side optical amplifier 161 compensates the loss of a signal propagating through the optical fiber. The transmission-side optical amplifier 166 amplifies the light intensity to a level suitable for long distance transmission, before inputting the signal to the optical fiber.

In FIG. 2A, the optical amplifier 161 includes a variable attenuator 61, a monitor 62-1, an Erbium-doped-fiber (EDF) 63-1, a monitor 62-2, and a driver 65-1. The monitor 62-1 controls the variable attenuator 61 so that the intensity of the light input to the EDF 63-1 is constant. This is because the loss due to the transmission line 50 is not necessarily constant on the reception side. Further, it is necessary to adjust the light intensity to a certain level to stabilize the amplitude between wavelengths. The driver 65-1 pumps the EDF 63-1 to stabilize the gain (amplitude) while monitoring the monitors 62-1, 62-2 provided before and after the amplifier 63-1.

In FIG. 2B, the optical amplifier 166 is on the transmission side, so that there is no need to consider fluctuations in losses due to the transmission line. Thus, the optical amplifier 166 has the same configuration as the configuration of FIG. 2A except for the optical attenuator 61.

The add/drop unit 140 will be described with reference to FIG. 3. Here, FIG. 3 is a block diagram of the add/drop unit 140. As shown in FIG. 3, the add/drop unit 140 is configured such that a variable attenuator 142 capable of varying the light intensity for each signal wavelength, and an optical monitor 143 are located before an add unit 146. As a result, the add/drop unit 140 is provided with constant output control for adjusting light intensities of signal wavelengths to be input to the transmission-side optical amplifier 166. Because of the constant output control, the light intensities of the signal wavelengths are adjusted at the output portion of the add unit 146. In this way, the signal wavelengths with equal intensities are input to the input portion of the following transmission-side optical amplifier 166. Here, the optical signal flow and the supervisory optical control signal flow are shown only in their input directions. However, the signal flows in their output directions are the same as in the input directions.

In order to increase the communication capacity of the existing OADM 700 having such a configuration, the following three methods can be considered: (1) increase the wavelength bandwidth to be accommodated in the OADM; (2) increase the wavelength density while keeping the wavelength bandwidth to be accommodated in the OADM; and (3) increase the signal speed (bit rate) per wavelength to be accommodated in the OADM.

In the case of the method (1) that increases the wavelength bandwidth, it is necessary to increase the amplification bandwidth of the optical amplifier, as well as to increase the wavelength bandwidth supported by the add/drop unit and the transponder unit. Increasing the amplification bandwidth of the optical amplifier leads to the necessity to achieve a wider range of gain flatness within the bandwidth required for the optical amplifier. As a result, the specification requirements for the optical amplifier are much more stringent. Further, it is necessary for the optical transmitter to achieve a wider range of emission wavelengths to emit a light in the transponder unit. As a result, like the optical amplifier, the specification requirements for the transponder unit are much more stringent. In addition, signal waveform degradation occurs due to nonlinear effects of the optical fiber in the vicinity of the zero-dispersion wavelength in which the wavelength dispersion equals zero, depending on the type of transmission line (optical fiber). Because of this phenomenon, even if the bandwidth is increased, the increased bandwidth may not be used depending on the type of optical fiber.

In the case of the method of (2) that increases the wavelength density, there is no need to increase the amplification bandwidth of the optical amplifying unit, but the density of the wavelength multiplexed light is increased within the optical fiber. As a result, the influence of nonlinearity of the optical fiber is significant. The signal waveform is degraded by wavelength interaction due to nonlinear effects such as four-wave-mixing and a mutual phase modulation effect. Thus, the transmission distance is very short, and a reproduction repeater is necessary for optical-electrical conversion to achieve a long distance transmission. This leads to an increase in system cost.

In the case of the method of (3) that increases the signal speed (bit rate) per wavelength while keeping the bandwidth, namely, that introduces signals having high communication speeds such as 40 Gbit/s and 100 Gbit/s, with respect to existing signals having a communication speed of about 10 Gbit/s. However, with an increase in the signal speed, the size of a window for determining the symbol, either “1” or “0”, is reduced. Thus, the influence of the signal wavelength degradation on the communication quality is significantly increased. Particularly, the influence of the wavelength degradation is very significant due to the nonlinear effects on the signal propagating through the optical fiber. This results in significant degradation of signal quality.

Further, with an increase in signal speeds, such as from 10 Gbit/s to 40 Gbit/s or 100 Gbit/s, the influence of the waveform degradation on the communication quality is significantly increased due to wavelength dispersion of the optical fiber. For this reason, the influence due to the wavelength dispersion of the optical fiber should be compensated by implementing more precise dispersion compensation design to cancel the wavelength dispersion of the transmission line.

Related Patent documents are JP-A No. 235412/2007 and JP-A No. 055025/2002, which will be described in the following.

In particular, it is necessary to accommodate signals with higher communication speeds such as 40 Gbit/s and 100 Gbit/s, in a wavelength division multiplexing system in which signals with a lower communication speed such as 10 Gbit/s are accommodated, in such a manner that different bit rates coexist. In other words, it is necessary to assign the signals with higher communication speeds such as 40 Gbit/s and 100 Gbit/s to unused wavelengths of the OADM in which signals with a lower communication speed such as 10 Gbit/s have been accommodated, without changing the existing OADM.

However, the OADM itself is designed to achieve longer distance and higher quality communication for the signals with a lower communication speed such as 10 Gbit/s. Thus, in the OADM, the output intensity of the add/drop unit 140, as well as the output intensity of the optical amplifying unit 160, are determined so that the optical parameters are optimized and actually used. When the signals with higher communication speed such as 40 Gbit/s and 100 Gbit/s are input to the OADM operated with the optical characteristics suitable for 10 Gbit/s, the nonlinear effects in the optical fiber excessively affect the higher speed signals. As a result, significant waveform degradation occurs. This is because, in the case of the high-speed signals of 40 Gbit/s and 100 Gbit/s, the time window for identifying information, either “1” or “0”, is one fourth or one tenth smaller than in the case of the signals with a lower speed such as 10 Gbit/s. Thus, small wavelength degradation leads to significant degradation of signal quality.

To solve this problem, JP-A No. 235412/2007 discloses an optical amplifying unit which is a combination of an optical amplifier and an add/drop unit, with a variable attenuator mounted in the add/drop unit to obtain an appropriate light output intensity for each wavelength. The light output intensity for each wavelength can be varied by the variable attenuator. With this configuration, when the accommodated wavelength is of the low-speed signals such as 10 Gbit/s having a high resistance against the nonlinear effects in the optical fiber, the output intensity can be adjusted to a relatively high level. When the accommodated wavelength is of the high-speed signals such as 40 Gbit/s and 100 Gbit/s having a small resistance against nonlinear effects in the optical fiber, it is difficult to increase the output intensity to a level equivalent to that of the 10 Gbit/s signals, so that the output intensity is adjusted to a relatively low level. Further, in the case of a different modulation format using phase modulation in which data is superimposed in the phase direction, instead of a simple superimposition of “1” or “0” signal in the amplitude direction, it is possible to adjust the output intensity so as to optimize the transmission characteristics.

However, the technology disclosed in JP-A No. 235412/2007 uses a new optical amplifying unit which is a combination of an optical amplifier and an add/drop unit. Thus, it is necessary to replace the existing optical amplifying unit currently providing services with the new optical amplifying unit. In other words, it is necessary to provide a new function, by stopping the existing services and replacing the existing optical amplifying unit with the optical amplifying unit having the new function. In addition, the replaced existing optical amplifying unit will not be used, posing a problem in terms of the effective use of property.

Further, in the ultra high-speed signals such as 40 Gbit/s and 100 Gbit/s, the influence of the waveform degradation due to the wavelength dispersion occurring in the optical fiber is much more significant than in the low-speed signals such as 10 Gbit/s. For example, the 40 Gbit/s signal has one fourth the bit rate of 10 Gbit/s in the time axis direction, and extends four times in the frequency axis direction. Thus, the influence due to wavelength dispersion increases even sixteen times, and the waveform degradation is very significant. For this reason, the dispersion compensation technology for cancelling the wavelength dispersion of the optical fiber, as well as the dispersion monitoring function for observing how accurately the dispersion compensation is performed, are very important.

In addition, the technology is designed to accommodate the signals such as 40 Gbit/s and 100 Gbit/s in an OADM accommodating the existing low-speed signals such as 10 Gbit/s. However, the existing OADM includes a dispersion compensation fiber, and the like, to perform appropriate dispersion compensation design with respect to the 10 Gbit/s signal, and cancel the wavelength dispersion of an optical fiber which is a transmission line. In order to accommodate the high-speed signals such as 40 Gbit/s and 100 Gbit/s in the existing OADM, at least more precise dispersion compensation design is necessary. Thus, an understanding of the process of the existing dispersion compensation design is very important.

Various propositions have been made concerning the wavelength dispersion monitoring signal that modulates light before transmission, measures after transmission, and evaluates the wavelength dispersion and the like. An example of which is disclosed in JP-A No. 055025/2002.

### SUMMARY OF THE INVENTION

The present invention solves the above problems by providing an optical transmission device for transmitting an optical signal, including: an optical transmitter for emitting an optical signal; a light source for emitting a light; and a polarization combiner for multiplexing the optical signal and the light in a mutually orthogonal polarization direction.

Further, the present invention solves the above problems by providing an optical transmission method including the steps of: transmitting an optical signal; emitting light; and multiplexing the optical signal and the light in a mutually orthogonal polarization direction.

The add/drop unit 140 includes a constant optical output control that is operated by the total light intensity included in a wavelength. When a new light is multiplexed with the 40 Gbit/s or 100 Gbit/s signal by polarization multiplexing, it is observed that the optical signal intensity itself simply increases. At this time, the constant optical output control in the add/drop unit 140 is operated by the total light intensity of the new light added to the original signal. The output intensity of the wavelength of the 40 Gbit/s or 100 Gbit/s signal for each polarization decreases inversely proportional to the light intensity of the newly added light source. Thus, the more the light intensity of the newly added light source is increased, the lower the output intensity of the wavelength of the 40 Gbit/s or 100 Gbit/s signal becomes. In other words, the output intensity of the optical signal can be adjusted to desired output intensity by appropriately adjusting the light intensity of the light source.

The light to be multiplexed with such transmission signals in a polarization direction is provided simultaneously with devices for 40 Gbit/s and 100 Gbit/s signals to be added. It is also possible to achieve high speed communication by integrating the light as a part of the devices for such high-speed signals. In this way, there is no need to change the existing device currently providing services. In addition, because the light can be incorporated into the devices providing the 40 Gbit/s and 100 Gbit/s signals to be added, there is no influence on the existing devices and services.

Further, the light is polarization multiplexed with the 40 Gbit/s or 100 Gbit/s signal in a mutually orthogonal polarization direction. Then, the light is polarization multiplexed on the transmission side, and propagates to the reception side in the same manner as the signal component, through the existing OADM including the add/drop unit and the optical amplifier. Such a light acts as a noise component on the signal component. Thus the signal component and the noise component are polarization separated on the reception side. Then, only the signal component is treated as a communication signal.

Further, it is also possible to superimpose new information on the light to be added to the high-speed signal, such as 40 Gbit/s or 100 Gbit/s, in a mutually orthogonal polarization direction. It is possible to superimpose a monitoring signal on the additional light to measure the wavelength dispersion of the optical fiber. This makes it possible to observe the value of the wavelength dispersion of the optical fiber that affects the signal component of the 40 Gbit/s or 100 Gbit/s signal.

In this case, an additional function that can observe the wavelength dispersion of the optical fiber on the transmission side is additionally superimposed on the light to be polarization multiplexed. The light from the light source, on which the additional function is superimposed, propagates through the existing OADM. On the reception side, the light is polarization separated from the signal component of the 40 Gbit/s or 100 Gbit/s signal. In this way, it is possible to extract only the light component with the additional function superimposed thereon. The extracted light component includes the influence of wavelength dispersion that affected the light component during propagation with the 40 Gbit/s or 100 Gbit/s signal. Thus, it is possible to observe the value of the wavelength dispersion affected during propagation, by analyzing the light source component that is polarization separated on the reception side. Further, by using the value of the wavelength dispersion affected the observed 40 Gbit/s or 100 Gbit/s signal, more precise dispersion compensation control can be performed with respect to the signal component.

According to the present invention, ultra high-speed communications such as 40 Gbit/s and 100 Gbit/s can be achieved, without any change in the OADM including a multiplexing/demultiplexing unit and an optical amplifying unit that are optimized for the existing low-speed signal such as 10 Gbit/s while reducing nonlinear effects in the optical fiber that affect optical signals.

### BRIEF DESCRIPTION OF THE DRAWINGS

Preferred embodiments of the present invention will now be described in conjunction with the accompanying drawings, in which;

FIG. 1 is a block diagram of an OADM;

FIGS. 2A and 2B are block diagrams of optical amplifiers;

FIG. 3 is a block diagram of an add/drop unit;

FIG. 4 is a block diagram showing a wavelength division multiplexing network;

FIG. 5 is a block diagram of an OADM;

FIG. 6 is a block diagram showing the operation mechanism of a transponder unit;

FIG. 7 is a block diagram of a transmission-side transponder;

FIGS. 8A and 8B are block diagrams of a polarization combiner and a polarization separator;

FIG. 9 shows level diagrams of an OADM having a polarization multiplexing function;

FIG. 10 is a block diagram of a transponder unit; and

FIG. 11 is a block diagram of a transmission transponder.

### DETAILED DESCRIPTION OF PREFERRED EMBODIMENTS

Hereinafter, preferred embodiments will be described with reference to the accompanying drawings, in which corresponding components are identified by the same reference numerals and the description will not be repeated.

### First Embodiment

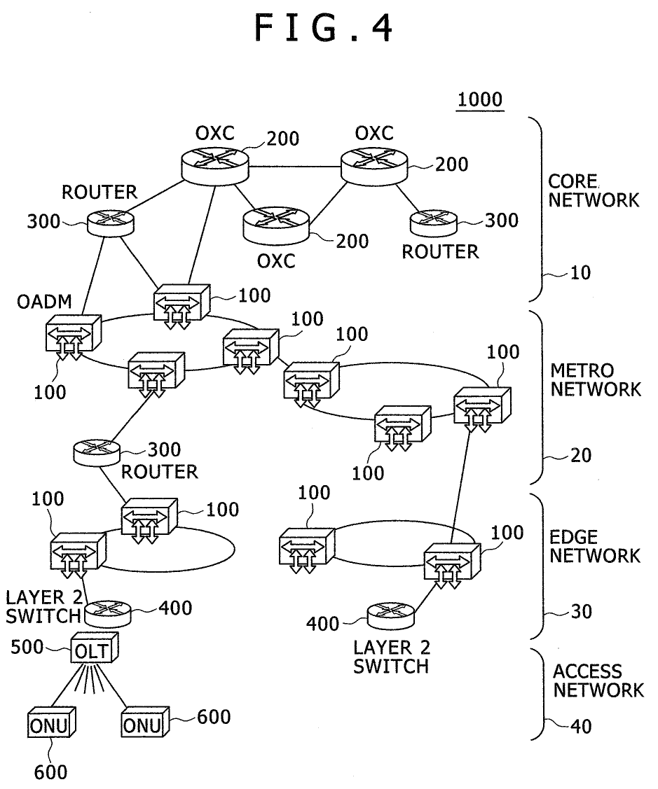

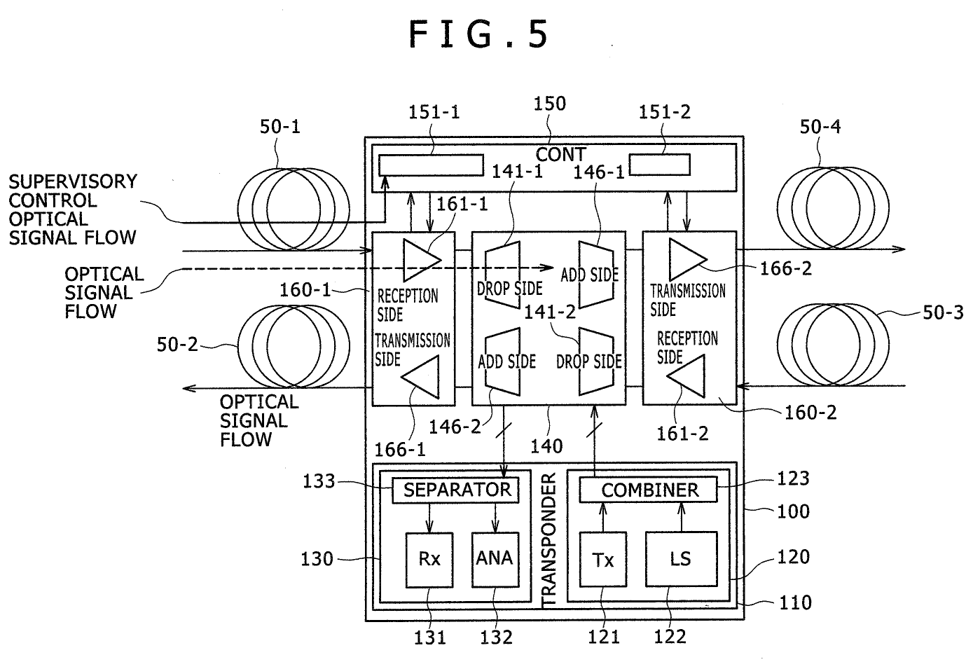

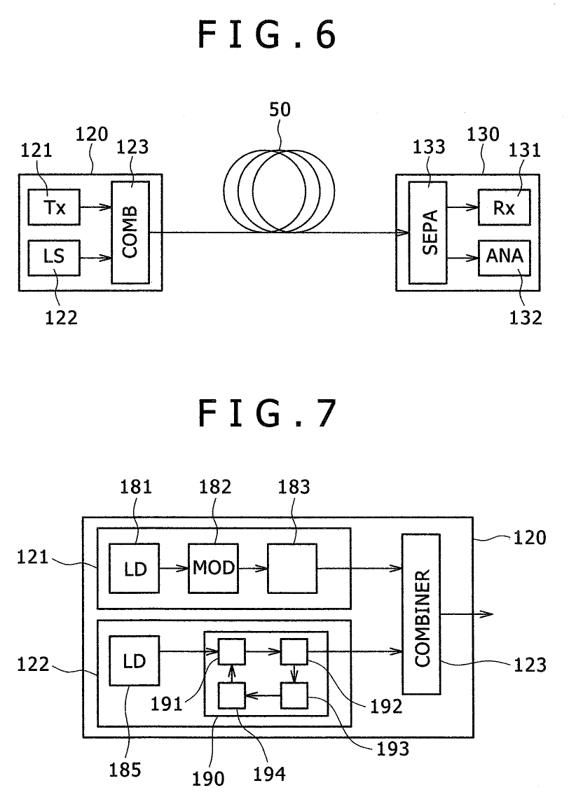

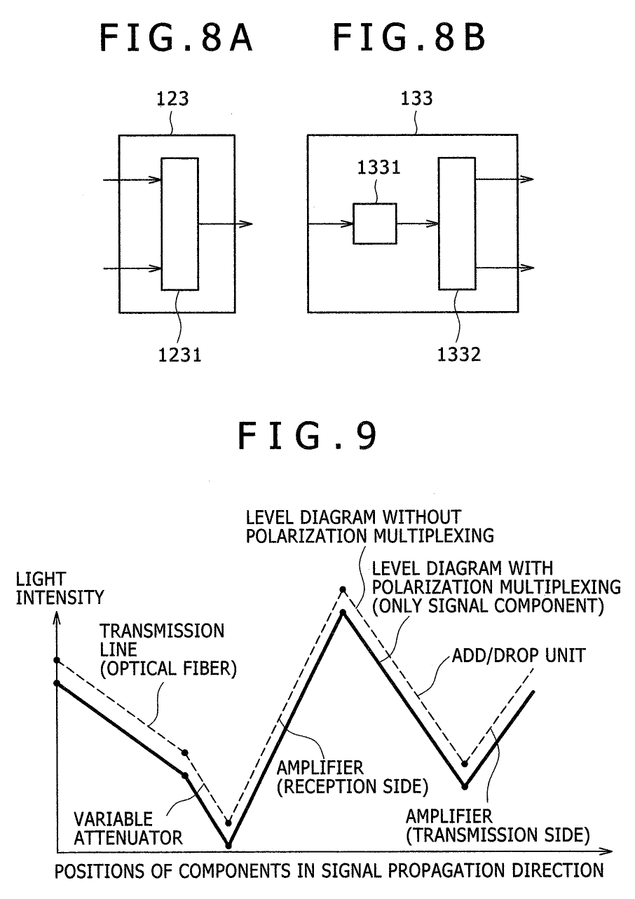

A first embodiment will be described with reference to FIGS. 4 to 9. Here, FIG. 4 is a block diagram showing a wavelength division multiplexing network. FIG. 5 is a block diagram of an OADM. FIG. 6 is a block diagram showing the operation mechanism of a transponder unit. FIG. 7 is a block diagram of a transmission-side transponder. FIGS. 8A and 8B are block diagrams of a polarization combiner and a polarization separator. FIG. 9 shows level diagrams of an OADM having a polarization multiplexing function.

Referring to FIG. 4, a description will be given of a network configuration using a wavelength division multiplexing optical transmission system. In FIG. 4, a network 1000 includes a core network 10, a metro network 20, an edge network 30, and an access network 40. The access network 40 provides fiber-to-the-home (FTTH) services to subscribers by region, using an optical line terminal (OLT) 500 and optical network units (ONUs) 600. The edge network 30 includes OADMs 100, layer-2 (L2) switches 400, and the like. The edge network 30 aggregates communications from subscribers in regions into groups of regions by plural L2 switches 400. The metro network 20 includes OADMs 100, a router 300, and the like. The metro network 20 aggregates the communications aggregated by the L2 switches into each city. The core network 10 includes optical cross connects (OXCs) 200, routers 300, and the like. The core network 10 efficiently transmits a large volume of communications aggregated in each city, over a long distance between large cities. In the network 1000, the OADM 100 is used for aggregating communications scattering in a relatively wide range into one site.

Referring to FIG. 5, a description will be given of the OADM 100 having a function for reducing nonlinear effects in the optical fiber that affect the high-speed signal such as 40 Gbit/s or 100 Gbit/s, by polarization multiplexing light with the signal in a mutually orthogonal polarization direction, according to the first embodiment.

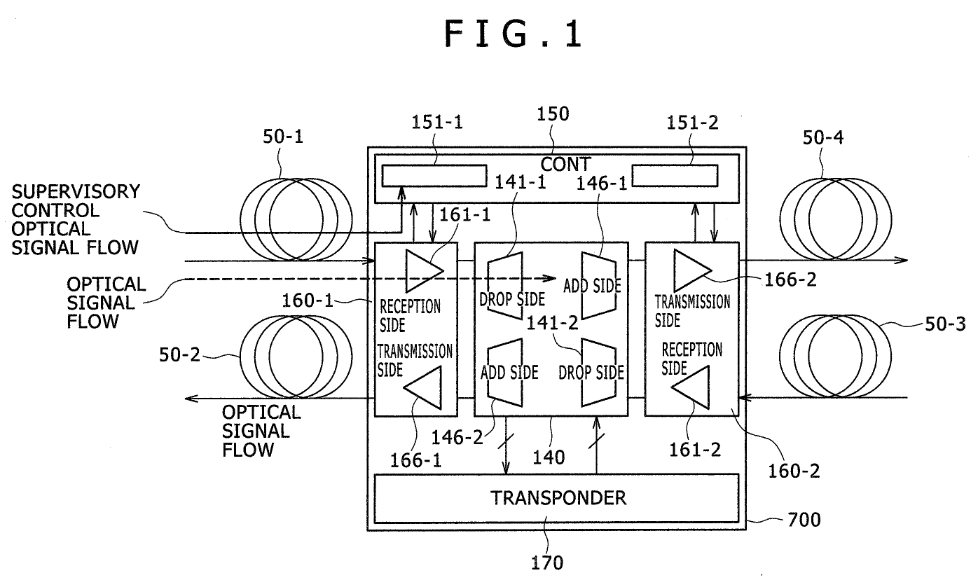

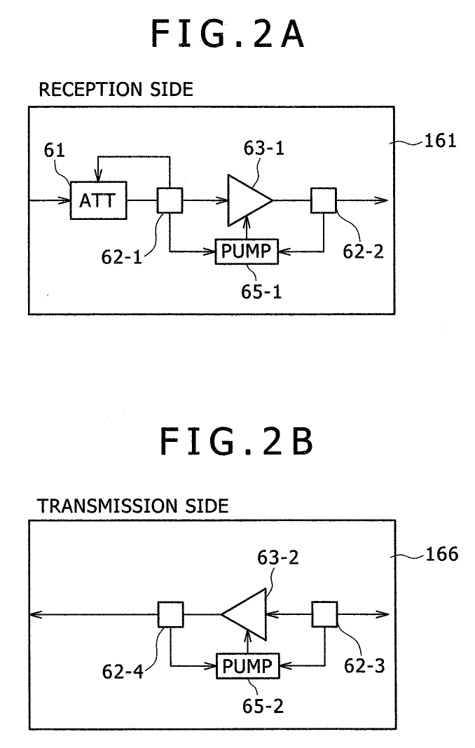

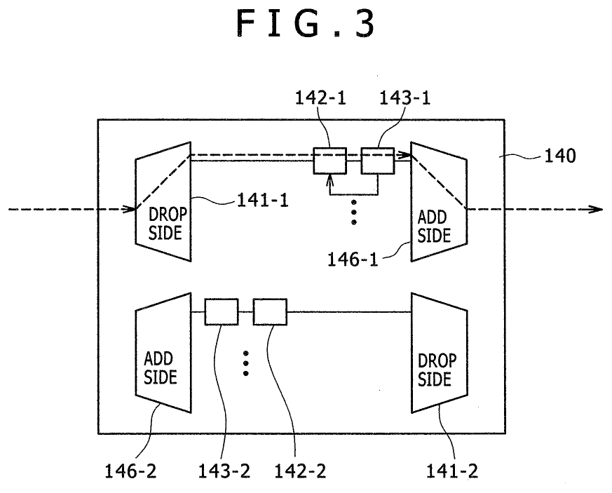

First, a description will be given of a new transponder unit 110 in which the light source is polarization multiplexed in a polarization direction, compared to the transponder unit 170 for converting an electrical signal to an optical signal and vise versa in the OADM 700 of FIG. 1.

The transponder unit 110 includes a transmission-side transponder 120 for transmitting a signal, and a reception-side transponder 130. The reception-side transponder 130 includes a polarization separator 133 for separating a polarization multiplexed signal into two polarization directions, and a signal reception unit 131 and an analyzer 132 which are reception units for the two polarization directions. The transmission-side transponder 120 includes a polarization combiner 123 for multiplexing in the polarization direction, and signal transmission unit 121 and a light source unit 122 which are signal sources for the respective polarization directions. Incidentally, the optical signals from the signal transmission unit 121 and the light source unit 122 are oriented in mutually orthogonal polarization directions with the same wavelengths (wavebands). Here, the wavelengths (wavebands) are identical, which means that the signals from the signal transmission unit 121 and the light source unit 122 are output to the same port in the wavelength demultiplexer. For this reason, DWDM and CWDM have different wavelength bandwidths.

Here, the signal component output from the signal transmission unit 121 of an upstream device is polarization separated by the polarization separator 133, and is input to the signal reception unit 131. Further, the signal component output from the light source unit 122 of the upstream device is also polarization separated by the polarization separator 133, and is input to the analyzer 132.

Referring to FIG. 6, a description will be given of the operation of both the transmission-side transponder 120 and the reception-side transponder 130. In FIG. 6, the polarization separator 133 of the reception-side transponder 130 receives a signal from the signal transmission unit 121 mounted in an OADM on the upstream side of the OADM 100. Then, the polarization separator 133 properly polarization separates the signal to the signal reception unit 131. The polarization separation is performed as follows. The signal received by the signal reception unit 131 is controlled so that the bit error rate of the received signal is the smallest. In this way, the polarization direction of the signal transmitted from the signal transmission unit 121, and the polarization direction of the signal reception unit 131 are identical. On the other hand, the light emitted from the light source unit 122 is input to the analyzer 132. The internal structure of the polarization separator 133 will be described later with reference to FIGS. 8A and 8B.

The transmission-side transponder 120 will be described in detail with reference to FIG. 7. In FIG. 7, the signal transmission unit 121 of the transmission-side transponder 120 includes a laser 181, a modulator 182, and an output intensity varying unit 183. The light source unit 122 includes a laser 185 and an output intensity varying unit 190. The output intensity varying units 183 and 190 have substantially the same configuration. Thus, only the configuration of the output intensity varying unit 190 will be described in detail below.

The output intensity varying unit 190 includes a variable attenuator 191, a light intensity splitter 192, a light intensity monitor 193, and a controller 194. The light intensity splitter 192 splits some of the light intensity to the polarization combiner 133, and to the light intensity monitor 193. The light intensity monitor 193 converts the received light intensity to an electrical signal, and transmits the electrical signal to the controller 194. The controller 194 controls the variable attenuator 191 so that the electrical signal received from the light intensity monitor 193 is constant.

The polarization combiner 123 and the polarization separator 133 will be described with reference to FIGS. 8A and 8B. In FIG. 8A, the polarization combiner 123 includes a polarization combining device 1231. In FIG. 8B, the polarization separator 133 includes a polarization controller 1331 and a polarization splitting device 1332. The polarization controller 1331 determines the main signal by optical intensity or clock. The polarization splitting device 1332 separates polarization surfaces. The polarization combining device 1231 combines two optical signals having different polarization surfaces.

Referring to FIG. 9, a description will be given of level diagrams of optical signal in the transmission line, variable attenuator, reception amplifier, add/drop unit, and transmission amplifier. In FIG. 9, the dotted line shows a level diagram without polarization multiplexing, and the solid line shows a level diagram with polarization multiplexing. It is shown that the light intensity indicated by the solid line is low compared to the level diagram indicated by the dotted line. This can be explained as follows. The optical signal component output from the signal transmission unit 121, and the light component output from the light source of the light source unit 122 are polarization multiplexed. The sum of the two components is used to control the light intensity to be constant at the variable attenuator 61 provided on the input side of the optical amplifying unit 160, and at the variable attenuator 142 of the add/drop unit 140. As a result, the level diagram with only the signal component is lower than the level diagram in normal operation. It is to be noted that the total light intensity of the two components, the signal component and the polarization multiplexed light source component, varies in substantially the same manner as the level diagram without polarization multiplexing.

As described above, the level diagram of the signal component with polarization multiplex is low. The influence of the nonlinear effects on the high-speed signals such as 40 Gbit/s and 100 Gbit/s decreases in the optical fiber, leading to an improvement in the quality of the high-speed signals. Incidentally, in the first embodiment, the analyzer 132 is not necessarily provided, and the output of the polarization separator 133 may simply be optically terminated.

According to the first embodiment, ultra high-speed communications such as 40 Gbit/s and 100 Gbit/s can be achieved, without any change in the OADM including a wavelength multiplexing/demultiplexing unit and an optical amplifying unit that are optimized for the existing transmission speed such as 10 Gbit/s, while reducing the nonlinear effects on the optical signals in the optical fiber.

### Second Embodiment

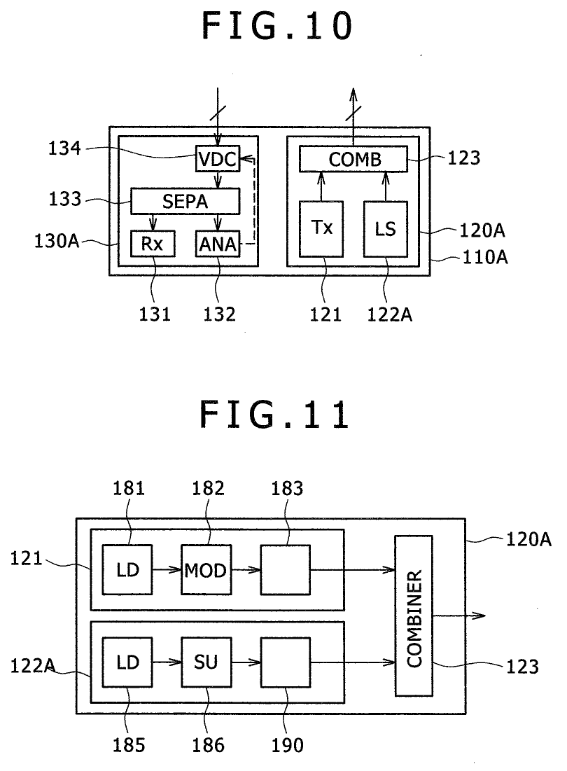

A second embodiment will be described with reference to FIGS. 10 and 11. Here, FIG. 10 is a block diagram of a transponder unit. FIG. 11 is a block diagram of a transmission-side transponder.

In FIG. 10, a transponder unit 110A includes a transmission-side transponder 120A for transmitting signals, and a reception-side transponder 130A. The reception-side transponder 130A includes a variable dispersion compensator 134 for compensating dispersion due to a transmission line 50, a polarization separator 133 for separating a polarization multiplexed signal into two polarization directions, and a signal reception unit 131 and an analyzer 132 which are reception units for the two polarization directions. The transmission-side transponder 120A includes a polarization combiner 123 for combining two polarizations, and a signal transmission unit 121 and a light source unit 122A which are signal sources for the respective polarization directions. Incidentally, the optical signals from the signal transmission unit 121 and the light source unit 122A are oriented in mutually orthogonal polarization directions with the same wavelength.

Here, the signal component output from the signal transmission unit 121 of an up stream device is precisely dispersion compensated by the variable dispersion compensator 134 and polarization separated by the polarization separator 133. Then, the signal is input to the signal reception unit 131. Further, the signal component output from the light source 122A of the upstream device is also precisely dispersion compensated by the variable dispersion compensator 134 and polarization separated by the polarization separator 133. Then, the signal is input to the analyzer 132.

The analyzer 132 analyzes the wavelength dispersion monitoring signal superimposed in the light source unit 122A, and controls the variable dispersion compensator 134 to provide an optimal wavelength dispersion compensation value.

The transmission-side transponder 120A will be described with reference to FIG. 11. In FIG. 11, the transmission-side transponder 120A includes the signal transmission unit 121, the light source unit 122A, and the polarization combiner 123. The light source unit 122A includes a laser 185, a dispersion monitoring function superimposing unit 186, and an output intensity varying unit 190. The dispersion monitoring function superimposing unit 186 modulates the intensity of the output light from the laser 185, and superimposes a low-speed wavelength dispersion monitoring signal on the output light.

The optical signals from both the laser 185 of the light source unit 122A and the laser 181 of the signal transmission unit 121 are oriented in mutually orthogonal polarization directions with the same wavelengths. In this case, the add/drop unit 140 and the optical amplifying unit 160, which are provided in the OADM 100, have a function for discriminating wavelengths. However, the add/drop unit 140 and the optical amplifying unit 160 do not have a function for discriminating polarization directions. Thus, the signal output from the signal transmission unit 121 of the transmission-side transponder 120A and the light output from the light source unit 122A thereof are respectively input to the signal reception unit 131 and the analyzer 132 in the reception-side transponder 130, through the same transmission line 50.

At this time, the wavelength dispersion information read in the analyzer 132 is affected by as much of the wavelength dispersion as the signal having propagated through the same transmission line 50. For this reason, the amount of the wavelength dispersion monitored by the analyzer 132 is equal to the amount of the wavelength dispersion affecting the transmission signal.

As described above, the wavelength dispersion monitoring function is superimposed on the light source to be multiplexed in the polarization direction, in addition to the light intensity adjustment function described in the first embodiment. As a result, both the light intensity adjustment function and the wavelength dispersion monitoring function can be provided.

According to the second embodiment, by superimposing the dispersion monitoring function on the light source to be polarization multiplexed, it is possible to monitor the amount of the wavelength dispersion on the high-speed signals such as 40 Gbit/s and 100 Gbit/s. As a result, more precise dispersion compensation can be performed using the information obtained by monitoring the wavelength dispersion. In addition, the signal quality can be further improved.

What is claimed is:

1. An optical transmission device for transmitting an optical signal, comprising:
an optical transmitter for emitting the optical signal;
a light source for emitting a light; and
a polarization combiner for multiplexing the optical signal and the light in a mutually orthogonal polarization direction.

2. The optical transmission device according to claim 1, further comprising a polarization separator, and an optical receiver for receiving the optical signal.

3. The optical transmission device according to claim 1,
wherein the optical signal and the light have the same wavelength band.

4. The optical transmission device according to claim 2,
wherein the optical signal and the light have the same wavelength band.

5. The optical transmission device according to claim 1,
wherein the light source superimposes a signal for monitoring wavelength dispersion due to a transmission fiber, on the light.

6. The optical transmission device according to claim 2,
wherein the light source superimposes a signal for monitoring wavelength dispersion due to a transmission fiber, on the light.

7. The optical transmission device according to claim 3,
wherein the light source superimposes a signal for monitoring wavelength dispersion due to a transmission fiber, on the light.

8. The optical transmission device according to claim 4,
wherein the light source superimposes a signal for monitoring wavelength dispersion due to a transmission fiber, on the light.

9. The optical transmission device according to claim 5,
wherein the optical receiver further includes a variable dispersion compensator, and an analyzer for receiving the signal for monitoring wavelength dispersion.

10. The optical transmission device according to claim 6,
wherein the optical receiver further includes a variable dispersion compensator, and an analyzer for receiving the signal for monitoring wavelength dispersion.

11. The optical transmission device according to claim 7,
wherein the optical receiver further includes a variable dispersion compensator, and an analyzer for receiving the signal for monitoring wavelength dispersion.

12. The optical transmission device according to claim 8,
wherein the optical receiver further includes a variable dispersion compensator, and an analyzer for receiving the signal for monitoring wavelength dispersion.

13. The optical transmission device according to claim 9,
wherein the optical receiver controls a dispersion compensation amount of the variable dispersion compensator, based on control of the analyzer with respect to the polarization multiplexed optical signal.

14. The optical transmission device according to claim 10,
wherein the optical receiver controls a dispersion compensation amount of the variable dispersion compensator, based on control of the analyzer with respect to the polarization multiplexed optical signal.

15. The optical transmission device according to claim 11,
wherein the optical receiver controls a dispersion compensation amount of the variable dispersion compensator, based on control of the analyzer with respect to the polarization multiplexed optical signal.

16. The optical transmission device according to claim 12,
wherein the optical receiver controls a dispersion compensation amount of the variable dispersion compensator, based on control of the analyzer with respect to the polarization multiplexed optical signal.

17. An optical transmission method comprising the steps of:
transmitting an optical signal;
emitting a light; and
multiplexing the optical signal and the light in a mutually orthogonal polarization direction.
